(19) United States
(12) Patent Application Publication
(10) Pub. No.: US 2011/0077943 A1
(43) Pub. Date: Mar. 31, 2011

(54) System for generating language model, method of generating language model, and program for language model generation

(75) Inventors: Kiyokazu Miki, Tokyo (JP); Kentaro Nagatomo, Tokyo (JP)

(73) Assignee: NEC CORPORATION, Tokyo (JP)

(21) Appl. No.: 12/308,400

(22) PCT Filed: Jun. 18, 2007
(86) PCT No.: PCT/JP2007/000641

§ 371 Date: Dec. 15, 2008

(30) Foreign Application Priority Data
Jun. 26, 2006 (JP) 2006-175101

(51) Int. Cl. G10L 15/00

(52) U.S. Cl. 704/250; 704/E15.001

(57) ABSTRACT

A first system for generating a language model is a system for generating a language model including: a topic history dependent language model storing unit; a topic history accumulation unit; and a language score calculation unit. In the system for generating the language model, a language score corresponding to history of topics is calculated by the language score calculation unit using history of topics in an utterance accumulated in the topic history accumulation unit and a language model stored in the topic history dependent language model storing unit. The topic history dependent language model storing unit may store a topic history dependent language model dependent on only most recent n topics. The topic history accumulation unit may accumulate only most recent n topics.

### TECHNICAL FIELD

The present invention relates to a system for generating a language model, a method of generating a language model, and a program for language model generation; and more particularly, relates to a system for generating a language model, a method of generating a language model, and a program for language model generation, each of which, in the case where a topic of a recognition object is changed, suitably operates taking into account its change tendency.

### BACKGROUND ART

An example of a conventional system for generating a language model is described in Patent Document 1 in a form incorporated in a voice recognition system. As shown in FIG. 4, the conventional voice recognition system is configured by a voice input unit 901, an acoustic analysis unit 902, a syllable recognition unit (first stage recognition) 904, a topic transition candidate point setting unit 905, a language model setting unit 906, a word string search unit (second stage recognition) 907, an acoustic model storing unit 903, a difference model 908, a language model 1 storing unit 909-1, a language model 2 storing unit 909-2, . . . , and a language model n storing unit 909-n.

The conventional voice recognition system having such configuration operates as in the following particularly with respect to an utterance including a plurality of topics.

That is, it is assumed that a predetermined number of topics exist in one utterance; the utterance is divided by setting all possible boundaries (for example, all points between syllables) as candidates of topic boundaries; all n numbers of topic-specific language models stored in language model k storing units (k=1 to n) are respectively applied to each section; a combination with highest score of a topic boundary and a language model is selected; and recognition result thus obtained is set as final recognition result. It can be conceivable that the combination of the selected language model generates a new language model depending on the utterance. This enables to output optimum recognition result even in the case where a plurality of topics is included in one utterance.

Patent Document 1: Japanese Unexamined Patent Publication No. 2002-229589 (p. 8 and FIG. 1)

### SUMMARY

A first problem is that, in the related system for generating the language model, with respect to an utterance that is a recognition object, the utterance is divided for every topic and an optimum language model is only used for every divided section; and therefore, a language model in consideration of the relationship of topics of a plurality of sections cannot be generated and optimum recognition result cannot be necessarily obtained. For example, when an utterance of a topic B is made following a topic A, it is highly likely that a subsequent utterance is influenced by the topics A and B and their order; however, the conventional system for generating the language model cannot generate a language model in which such a change in topic is reflected.

The reason is that the conventional system for generating the language model divides an utterance into the number of sections which are determined for every topic determined with respect to a predetermined utterance and only selects the optimum language model for each section; and consequently, a language model which estimates a next utterance is not generated by effectively using history of the topics themselves.

An exemplary object of the present invention is to provide a system for generating a language model, a method of generating a language model, and a program for language model generation, each of which is capable of generating a suitable language model corresponding to history of topics that has been made in a recognition object so far.

According to an exemplary aspect of the invention, there is provided a system for generating a language model including: a topic history dependent language model storing unit; a topic history accumulation unit; and a language score calculation unit. In the system for generating the language model, a language score corresponding to history of topics is calculated by the language score calculation unit using history of topics in an utterance accumulated in the topic history accumulation unit and a language model stored in the topic history dependent language model storing unit.

In the system for generating the language model, the topic history dependent language model storing unit may store a topic history dependent language model dependent on only most recent n topics.

In the system for generating the language model, the topic history accumulation unit may accumulate only most recent n topics.

In the system for generating the language model, the topic history dependent language model storing unit may store a topic-specific language model, and the language score calculation unit may select a language model from the topic-specific language models according to the topic history accumulated in the topic history accumulation unit and may calculate the language score using a new language model generated by combining the selected language models.

In the system for generating the language model, the language score calculation unit may select a topic-specific language model corresponding to the topic accumulated in the topic history accumulation unit.

In the system for generating the language model, the language score calculation unit may linearly couple probability parameters of the selected topic-specific language models.

In the system for generating the language model, the language score calculation unit may further use a coefficient which is smaller for an older topic in the topic history in the case of linear coupling.

In the system for generating the language model, the topic history dependent language model storing unit may store a topic-specific language model in which a distance can be defined between the language models, and the language score calculation unit may select a topic-specific language model corresponding to the topic accumulated in the topic history accumulation unit and a different topic-specific language model which is small in distance with said topic-specific language model corresponding to the topic.

In the system for generating the language model, the language score calculation unit may linearly couple probability parameters of the selected topic-specific language models.

In the system for generating the language model, the language score calculation unit may further use a coefficient which is smaller for an older topic in the topic history in the case of linear coupling.

In the system for generating the language model, the language score calculation unit may further use a coefficient which is smaller for a topic-specific language model which is farther in distance from the topic-specific language model of the topic appearing in the topic history in the case of linear coupling.

Furthermore, according to another exemplary aspect of the invention, there is provided a method of generating a language model in a system for generating a language model which includes a topic history dependent language model storing unit, a topic history accumulation unit, and a language score calculation unit. In the method of generating the language model, a language score corresponding to history of topics is calculated by the language score calculation unit using history of topics in an utterance accumulated in the topic history accumulation unit and a language model stored in the topic history dependent language model storing unit.

Still furthermore, according to the present invention, there is provided a program for making a computer function as the above mentioned system for generating the language model.

Yet furthermore, according to another exemplary aspect of the invention, there is provided a voice recognition system including a voice recognition unit which performs voice recognition with reference to a language model generated in the above mentioned system for generating the language model.

Further, according to the present invention, there is provided a voice recognition method including a voice recognition unit which performs voice recognition with reference to a language model generated in the above mentioned method of generating the language model.

Still further, according to the present invention, there is provided a program which is for making a computer function as the above mentioned voice recognition system.

An effect of the present invention is that there can be generated a language model which suitably operates with respect to a recognition object in which topic changes.

The reason is that history of topics having been generated in a recognition object so far is accumulated and the accumulated topic history is used as information; and accordingly, a change in topic can be suitably reflected on a language model to be used next.

According to the present invention, it is possible to apply for use in a voice recognition apparatus which recognizes a voice and a program which is for achieving voice recognition by a computer. Furthermore, the present invention can be applied for use in recognizing not only a voice but also a character.

### BRIEF DESCRIPTION OF THE DRAWINGS

The above mentioned object and other objects, features, and advantages will be more apparent from the following description of certain exemplary embodiments taken in conjunction with the accompanying drawings, in which:

FIG. 1 is a block diagram showing a configuration of a first exemplary embodiment;

FIG. 2 is a flow chart showing the operation of the first exemplary embodiment;

FIG. 3 is a block diagram showing a configuration of a second exemplary embodiment; and

FIG. 4 is a block diagram showing a configuration of a related art.

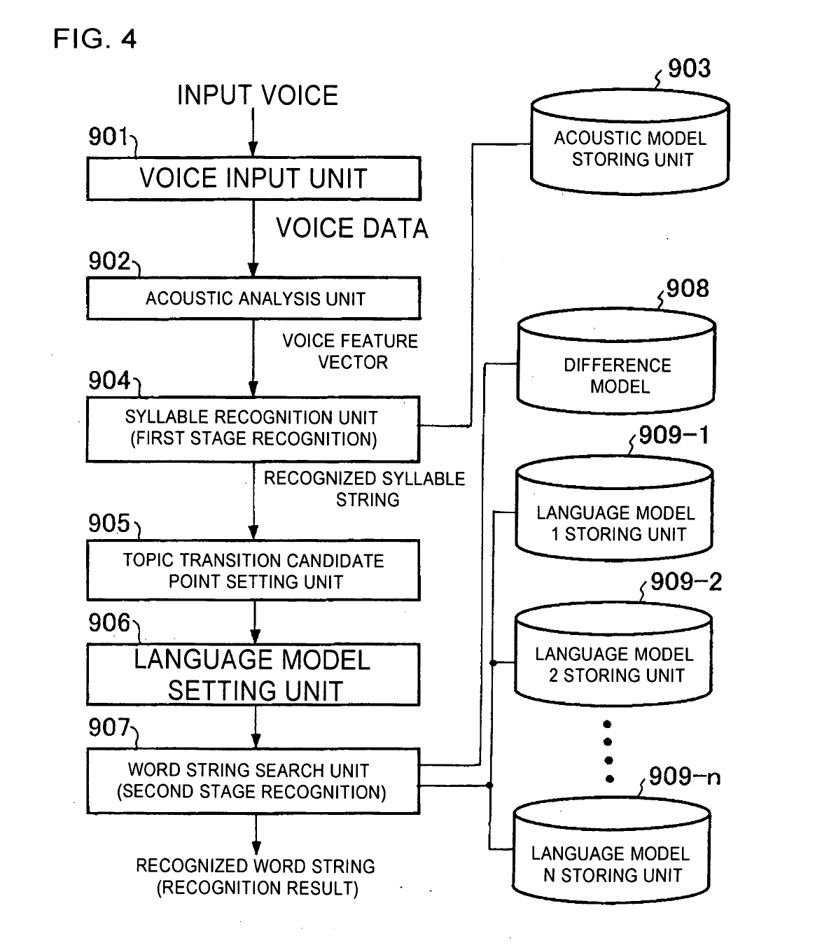

### EXEMPLARY EMBODIMENT

Exemplary embodiments for carrying out the present invention will be described below in detail with reference to the drawings.

A system for generating a language model according to one exemplary embodiment includes a topic history accumulation unit 109, a topic history dependent language model storing unit 105, and a language score calculation unit 110. History of topics in a recognition object accompanied by time sequence is accumulated in the topic history accumulation unit 109. In the language score calculation unit 110, a language score for use in recognition is calculated by simultaneously using a topic history dependent language model stored in the topic history dependent language model storing unit 105 and the topic history accumulated in the topic history accumulation unit 109.

By adopting such configuration, a language model corresponding to earlier topic history with respect to a recognition object to be input next can be generated; and thus, an object of the present invention can be achieved.

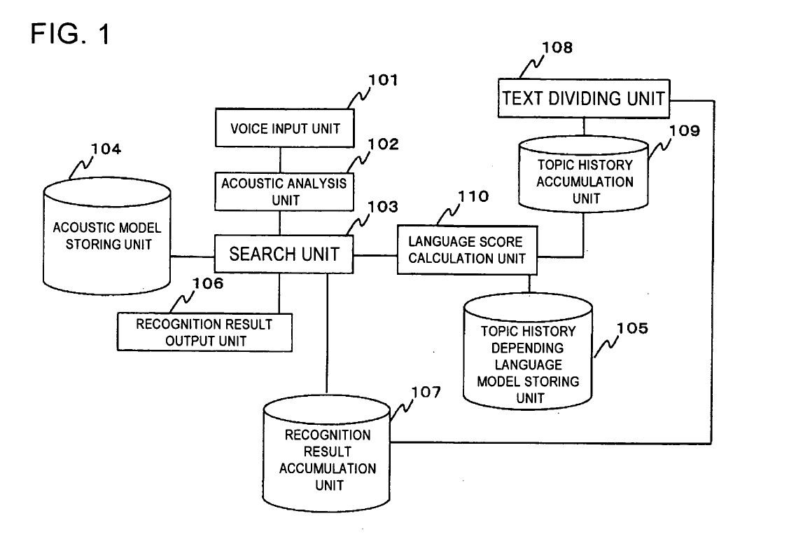

Referring to FIG. 1, the first exemplary embodiment of the present invention includes a voice input unit 101, an acoustic analysis unit 102, a search unit 103, an acoustic model storing unit 104, the topic history dependent language model storing unit 105, a recognition result output unit 106, a recognition result accumulation unit 107, a text dividing unit 108, the topic history accumulation unit 109, and the language score calculation unit 110.

Each of these units briefly operates as follows.

The voice input unit 101 inputs a voice signal. More specifically, for example, an electrical signal input from a microphone is sampled, digitized, and input. The acoustic analysis unit 102 performs acoustic analysis to convert an input voice signal to a feature quantity suitable for voice recognition. More specifically, as the feature quantity, linear predictive coding (LPC), mel frequency cepstrum coefficient (MFCC), and the like, for example, are often used. The search unit 103 searches recognition result from the voice feature quantity obtained from the acoustic analysis unit 102 in accordance with an acoustic model stored in the acoustic model storing unit 104 and the language score which is given by the language score calculation unit 110. The acoustic model storing unit 104 stores a standard pattern of voice represented in feature quantity. More specifically, for example, a model such as a hidden Markov model (HMM) and a neural net is often used. The language score calculation unit 110 calculates the language score using the topic history accumulated in the topic history accumulation unit 109 and the topic history dependent language model stored in the topic history dependent language model storing unit 105. The topic history dependent language model storing unit 105 stores the language model whose score changes depending on the topic history. A topic is, for example, a field to which a subject matter in the utterance belongs, and includes ones that are classified by human beings like politics, economics, and sports, and that are automatically obtained from texts by clustering or the like. For example, in a language model defined in a word unit, the topic history dependent language model dependent on past n topics is represented as follows:

P(w)=P(w|h,tₖ₋ₙ₊₁, . . . , tₖ) [Equation 1]

where t represents a topic, suffix represents time sequence, and h represents a context other than the topic. For example, in the case of an N-gram language model, it is past N words. In such language model, a learning corpus is divided for every topic, and estimation can be made using maximum likelihood estimation or the like if the type of topics is given to each section.

Furthermore, a topic history dependent language model to be represented as in the following is also conceivable.

P(w)=P(w|h,tₖ₊₁)P(tₖ₊₁|tₖ₋ₙ₊₁, . . . , tₖ) [Equation 2]

This is, namely, a model to directly estimate a topic tₖ₊₁ to which the next utterance is considered to belong. A unit of topic history for use in a context may be set to each switching point of topics, or may be set to each given time, each given number of words, each given number of utterances or each voice section acoustically delimited by silence, for example. As a method of obtaining the topic history dependent language model, in addition to the previously described method, for example, distribution of duration time of a topic may be incorporated in a model, or priori knowledge may be incorporated. As the priori knowledge, for example, there is a greater chance that the same topic continues when topic changes less often, there is a greater chance that a topic is changed to a different topic when there is a large change in topic, and the like. As the context, all the past n topics are not necessarily used; but only a necessary context can be used. For example, it is conceivable that a predetermined topic whose level of importance is small is not used; a topic whose duration time is equal to or less than a given amount is not used; a topic whose total number of times of appearance in a context is equal to or less than a given number is not used, and the like. The recognition result output unit 106 outputs recognition result obtained by the search unit 103. For example, it is conceivable that recognition result text is displayed on a screen. The recognition result accumulation unit 107 accumulates the recognition result obtained by the search unit 103 in accordance with a temporal sequence. The recognition result accumulation unit 107 may accumulate all the recognition results, or may accumulate a given amount of recent results.

The text dividing unit 108 divides the recognition result text accumulated in the recognition result accumulation unit 107 according to the topic. In this case, the utterance which has been recognized so far is divided in accordance with the topic. More specifically, a unit which divides the text according to the topic is achieved using, for example, “T. Koshinaka et al., “AN HMM-BASED TEXT SEGMENTATION METHOD USING VARIATIONAL BAYES APPROACH AND ITS APPLICATION TO LVCSR FOR BROADCAST NEWS,” Proceedings of ICASSP 2005, pp. I-485 to 488, 2005.,” or the like. The topic history accumulation unit 109 accumulates a temporal sequence of the topics obtained by the text dividing unit 108 in correspondence with the utterance. The topic history accumulation unit 109 may accumulate the topic history of all the topics, or may accumulate a given amount of recent history. In particular, in the case of the topic history dependent language model dependent on the aforementioned past n topics, it is sufficient if recent n topics are accumulated. The topic history accumulated in the topic history accumulation unit 109 is used when the language score is calculated using the language model stored in the topic history dependent language model storing unit 105 in the language score calculation unit 110.

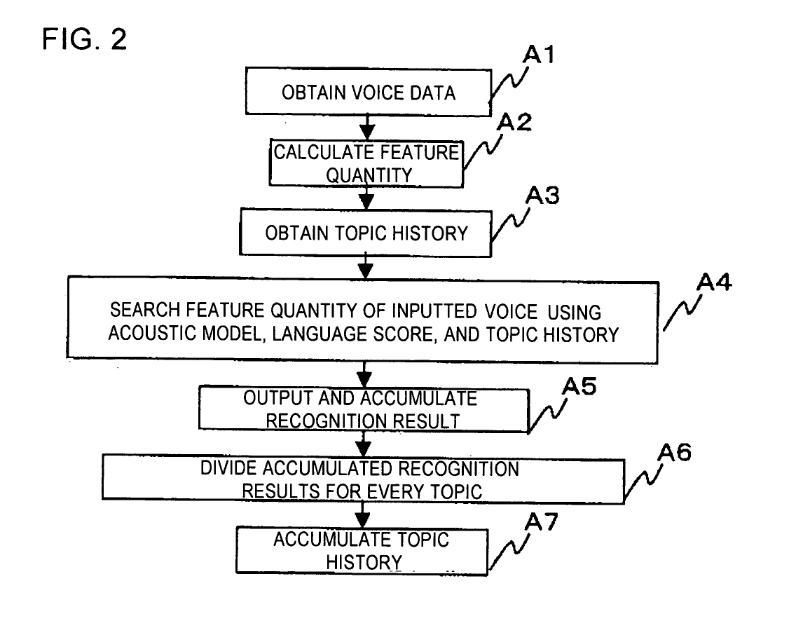

Next, the entire operation of the present exemplary embodiment will be described in detail with reference to FIG. 1 and a flow chart shown in FIG. 2.

First, voice data is input in the voice input unit 101 (step A1 shown in FIG. 2). Next, the input voice data is converted to a feature quantity suitable for voice recognition by the acoustic analysis unit 102 (step A2). Since the voice recognition is performed by the search unit 103, topic history accumulated in the topic history accumulation unit 109 is obtained by the language score calculation unit 110 (step A3). In the topic history accumulation unit 109, no accumulation state may be set as an initial state, or in the case a topic can be estimated in advance, a state in which the topic is accumulated may be set as the initial state. Next, search is performed in the search unit 103 with respect to the obtained voice feature quantity using an acoustic model stored in the acoustic model storing unit 104 and a language score calculated by the language score calculation unit 110 (step A4). Recognition result obtained by this is suitably output by the recognition result output unit 106, and is accumulated in the recognition result accumulation unit 107 in accordance with order of time (step A5).

In the recognition result accumulation unit 107, no accumulation state may be set as an initial state, or in the case where text of the topic related to an utterance is obtained in advance, a state in which the text is accumulated may be set as the initial state. Next, the recognition results accumulated in the recognition result accumulation unit 107 is divided for every topic by the text dividing unit 108 (step A6). At this step, all the accumulated recognition results may be processed as objects, or only newly added recognition result may be processed as object. Lastly, in accordance with the division obtained by the text dividing unit 108, the topic history is accumulated in the topic history accumulation unit 109 in accordance with order of time (step A7). Afterward, the above mentioned processes are repeated every time voice is input. For easy understanding, the entire operation is described by setting an input voice as a unit of the operation; however, in practice, the respective processes may be operated in parallel by pipeline processing, or the processes may be operated so as to perform a process for a plurality of voices at a time. Recognition is made using topic history in this system; however, not only topics of the utterance having been recognized so far, but also a topic of utterance that is the present recognition object may be added to the topic history. In this case, the topic of the present utterance needs to be estimated. For example, recognition is once performed using a language model independent of the topic and estimates the topic, and recognition is performed again using the topic history dependent language model with respect to the same utterance.

Next, an effect of the present exemplary embodiment will be described.

The present exemplary embodiment is configured such that the topic history accumulation unit is provided and the language score is performed using the topic dependent language model by setting the topic history accumulated in the topic history accumulation unit as the context; and therefore, there can be generated the language model which can recognize with high accuracy with respect to an utterance in which topic changes.

Next, a second exemplary embodiment of the present invention will be described in detail with reference to the drawings.

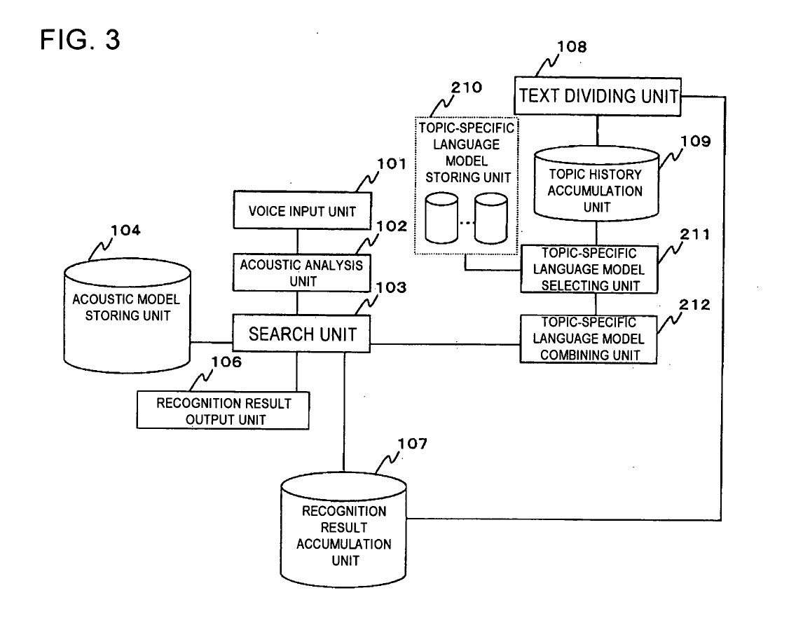

Referring to FIG. 3, as compared with the first exemplary embodiment, a topic-specific language model storing unit 210 is added in place of the topic history dependent language model storing unit 105, a topic-specific language model selecting unit 211 is added in place of the language score calculation unit 110 and a topic-specific language model combining unit 212 is added.

Each of these units briefly operates as follows.

The topic-specific language model storing unit 210 stores a plurality of language models created for every topic. Such language models can be obtained by dividing learning corpus using, for example, the aforementioned text dividing method and by creating the language model for every topic. The topic-specific language model selecting unit 211 selects a suitable language model from the topic-specific language models stored in the topic-specific language model storing unit 210 in accordance with topic history accumulated in the topic history accumulation unit 109. For example, the language model related to recent n topics obtained from the topic history can be selected. The topic-specific language model combining unit 212 generates one topic history dependent language model by combining the language models selected by the topic-specific language model selecting unit 211. For example, as the language model dependent on the recent n topics, the following topic history dependent language model dependent on past n topics can be generated using each language model of the recent n topics.

$$P ( w \vert h , {t}_{k - n + 1} , ⋯ , {t}_{k} ) = {\sum }_{i} {λ}_{i} P ( w \vert h , {t}_{i} ) \qquad [ Equation 3 ]$$

where t is a topic, and h is a context other than the topic. λ is a combining coefficient to be given for every topic appearing in the topic history. λ is, for example, 1/n (uniform), or may be set to be large in the case of a recent topic and to be smaller in the case of an earlier topic. In the right side, an example in which there is one context t is described; however, the case where there are a plurality of is similarly conceivable. In the case where a distance can be defined among the language models stored in the topic-specific language model storing unit 210, not only the language model related to the topic appearing in the topic history but also a language model close to the aforementioned language model can be selected in the topic-specific language model selecting unit 211. For such distance, a degree of vocabulary overlap between the language models, a distance between distributions in the case where the language models are represented by probability distributions, degree of similarity of the learning corpus that is a source of the language models, and the like can be used. In such a case, in the topic-specific language model combining unit 212, as the language model dependent on the recent n topics, for example, the following topic history dependent language model dependent on the past n topics can be generated using the language model of the recent n topics and the adjacent language models.

$$P ( w \vert h , {t}_{k - n + 1} , ⋯ , {t}_{k} ) = {\sum }_{i} {λ}_{i} {\sum }_{d ( {t}_{i} , {t}_{j} ) < θ} {ω}_{ij} P ( w \vert h , {t}_{j} ) \qquad [ Equation 4 ]$$

where t is a topic, and h is a context other than the topic. λ is a combining coefficient to be given for every topic appearing in topic history. ω is a combining coefficient to be given for every language model adjacent to a certain topic, d(t1, t2) is a distance between the language model of a topic t1 and the language model of a topic t2, and θ is a constant. ω can be set to a value which is inversely proportional to d, for example.

Next, an effect of the best mode for carrying out the present invention will be described.

The best mode for carrying out the present invention is configured such that the topic-specific language model storing unit storing topic-specific language models created for every topic of a plurality of topics is provided and the topic history dependent language model is generated by suitably combining them in accordance with the topic history; and therefore, the language model capable of recognizing with high accuracy with respect to the voice in which topic changes can be generated without preparing the topic history dependent language model in advance.

In addition, systems shown in FIGS. 1 and 3 can be achieved by hardware, software, or a combination thereof. Achievement made by software means that it can be achieved by a computer by executing a program for making the computer function as the aforementioned system.

1. A system for generating a language model, comprising:
a topic history dependent language model storing unit;
a topic history accumulation unit; and
a language score calculation unit,
wherein a language score corresponding to history of topics is calculated by said language score calculation unit using history of topics in an utterance accumulated in said topic history accumulation unit and a language model stored in said topic history dependent language model storing unit.

2. The system for generating the language model as set forth in claim 1,
wherein said topic history dependent language model storing unit stores a topic history dependent language model dependent on only most recent n topics.

3. The system for generating the language model as set forth in claim 1,
wherein said topic history accumulation unit accumulates only most recent n topics.

4. The system for generating the language model as set forth in claim 1,
wherein said topic history dependent language model storing unit stores a topic-specific language model, and
said language score calculation unit selects a language model from the topic-specific language models according to the topic history accumulated in said topic history accumulation unit and calculates the language score using a new language model generated by combining the selected language models.

5. The system for generating the language model as set forth in claim 4,
wherein said language score calculation unit selects a topic-specific language model corresponding to the topic accumulated in said topic history accumulation unit.

6. The system for generating the language model as set forth in claim 4,
wherein said language score calculation unit linearly couples probability parameters of the selected topic-specific language models.

7. The system for generating the language model as set forth in claim 6,
wherein said language score calculation unit further uses a coefficient which is smaller for an older topic in the topic history in the case of linear coupling.

8. The system for generating the language model as set forth in claim 4,
wherein said topic history dependent language model storing unit stores a topic-specific language model in which a distance can be defined between the language models, and
said language score calculation unit selects a topic-specific language model corresponding to the topic accumulated in said topic history accumulation unit and a different topic-specific language model which is small in distance with said topic-specific language model corresponding to the topic.

9. The system for generating the language model as set forth in claim 8,
wherein said language score calculation unit linearly couples probability parameters of the selected topic-specific language models.

10. The system for generating the language model as set forth in claim 9,
wherein said language score calculation unit further uses a coefficient which is smaller for an older topic in the topic history in the case of linear coupling.

11. The system for generating the language model as set forth in claim 9,
wherein said language score calculation unit further uses a coefficient which is smaller for a topic-specific language model which is farther in distance from the topic-specific language model of the topic appearing in the topic history in the case of linear coupling.

12. A voice recognition system comprising a voice recognition unit which performs voice recognition with reference to a language model generated in the system for generating the language model as set forth in claim 1.

13. A method of generating a language model in a system for generating a language model which comprises a topic history dependent language model storing unit, a topic history accumulation unit, and a language score calculation unit,
wherein a language score corresponding to history of topics is calculated by said language score calculation unit using history of topics in an utterance accumulated in said topic history accumulation unit and a language model stored in said topic history dependent language model storing unit.

14. The method of generating the language model as set forth in claim 13,
wherein said topic history dependent language model storing unit stores a topic history dependent language model dependent on only most recent n topics.

15. The method of generating the language model as set forth in claim 13,
wherein said topic history accumulation unit accumulates only most recent n topics.

16. The method of generating the language model as set forth in claim 13,
wherein said topic history dependent language model storing unit stores a topic-specific language model, and
said language score calculation unit selects a language model from the topic-specific language models according to the topic history accumulated in said topic history accumulation unit and calculates the language score using a new language model generated by combining the selected language models.

17. The method of generating the language model as set forth in claim 16,
wherein said language score calculation unit selects a topic-specific language model corresponding to the topic accumulated in said topic history accumulation unit.

18. The method of generating the language model as set forth in claim 16,
wherein said language score calculation unit linearly couples probability parameters of the selected topic-specific language models.

19. The method of generating the language model as set forth in claim 18,
wherein said language score calculation unit further uses a coefficient which is smaller for an older topic in the topic history in the case of linear coupling.

20. The method of generating the language model as set forth in claim 16,
wherein said topic history dependent language model storing unit stores a topic-specific language model in which a distance can be defined between the language models, and
said language score calculation unit selects a topic-specific language model corresponding to the topic accumulated in said topic history accumulation unit and a different topic-specific language model which is small in distance with said topic-specific language model corresponding to the topic.

21. The method of generating the language model as set forth in claim 20,
wherein said language score calculation unit linearly couples probability parameters of the selected topic-specific language models.

22. The method of generating the language model as set forth in claim 21,
wherein said language score calculation unit further uses a coefficient which is smaller for an older topic in the topic history in the case of linear coupling.

23. The method of generating the language model as set forth in claim 21,
wherein said language score calculation unit further uses a coefficient which is smaller for a topic-specific language model which is farther in distance from the topic-specific language model of the topic appearing in the topic history in the case of linear coupling.

24. A voice recognition method comprising a voice recognition unit which performs voice recognition with reference to a language model generated in the method of generating the language model as set forth in claim 13.

25. A computer readable medium which is for making a computer function as the system for generating the language model as set forth in claim 1.

26. A computer readable medium which is for making a computer function as the voice recognition system as set forth in claim 12.
